(19) United States
(12) Patent Application Publication
(10) Pub. No.: US 2026/0356868 A1
(43) Pub. Date: Nov. 12, 2026

(54) PREPARATION METHOD AND USE OF PAINT SLUDGE-DERIVED ACTIVATED CARBON-MOF COMPOSITE ELECTRODE MATERIAL

(71) Applicant: Zhejiang Normal University, Jinhua City (CN)

(72) Inventors: Yang JIAO, Jinhua City (CN); Sunpeng SHAN, Jinhua City (CN); Yanchao XU, Jinhua City (CN); Jianrong CHEN, Jinhua City (CN); Shuke LI, Jinhua City (CN); Yan XU, Jinhua City (CN); Banglin CHEN, Jinhua City (CN)

(21) Appl. No.: 19/328,890

(22) Filed: Sep. 15, 2025

(30) Foreign Application Priority Data
May 8, 2025 (CN) 202510589515.8

(51) Int. Cl. C07F 15/02; H01M 4/60

(52) U.S. Cl. CPC C07F 15/02; H01M 4/60

(57) ABSTRACT

Provided are a preparation method and use of a paint sludge-derived activated carbon-MOF composite electrode material. The preparation method includes: carbonizing a paint sludge to obtain a paint sludge-derived activated carbon, where the paint sludge-derived activated carbon includes Al and CaCO₃; subjecting a metal salt, an inorganic base, and a first organic solvent to a first mixing to obtain a first mixed solution, where the metal salt includes a mixed salt of a cerium salt and an iron salt; subjecting 2-methylimidazole and a second organic solvent to a second mixing to obtain a second mixed solution; subjecting the first mixed solution, the second mixed solution, and the paint sludge-derived activated carbon to a third mixing, and subjecting a resulting mixture to a hydrothermal reaction to obtain a precursor material; and calcining the precursor material to obtain the paint sludge-derived activated carbon-MOF composite electrode material.

### CROSS REFERENCE TO RELATED APPLICATION

This patent application claims the benefit and priority of Chinese Patent Application No. 202510589515.8 filed with the China National Intellectual Property Administration on May 8, 2025, the disclosure of which is incorporated by reference herein in its entirety as part of the present application.

### TECHNICAL FIELD

The present disclosure belongs to the technical field of electrocatalytic water decomposition, and in particular relates to a preparation method and use of a paint sludge-derived activated carbon-metal organic framework (MOF) composite electrode material.

### BACKGROUND

Currently, the technology of hydrogen production by water electrolysis is of great concern due to the high energy density and zero contamination properties of hydrogen. However, the high cost of precious metal electrocatalysts limits the large-scale industrial applications. As a result, the development of low-cost, high-performance precious metal electrocatalysts has become the focus of research.

Paint sludge (PS) is a solid waste produced by the paint industry, which is usually treated by incineration and landfill, affecting not only the health of the air and soil environment, but also wasting land resources. Paint sludge-derived activated carbon (PAC) is produced by subjecting paint sludges to thermal drying to remove water and volatile solvents. However, an electrocatalytic electrode prepared by using the paint sludge-derived activated carbon as an active material has low catalytic performance when used in electrocatalytic water decomposition, so it is necessary to further improve the electrocatalytic performance thereof.

### SUMMARY

An object of the present disclosure is to provide a preparation method and use of a paint sludge-derived activated carbon-MOF composite electrode material.

To achieve the object described above, the present disclosure provides the following technical solutions.

The present disclosure provides a method for preparing a paint sludge-derived activated carbon-MOF composite electrode material, including the following steps:
carbonizing a paint sludge to obtain a paint sludge-derived activated carbon, where the paint sludge-derived activated carbon includes Al and CaCO₃;
subjecting a metal salt, an inorganic base, and an organic solvent to a first mixing to obtain a first mixed solution, wherein the metal salt includes a mixed salt of a cerium salt and an iron salt;
subjecting 2-methylimidazole and an organic solvent to a second mixing to obtain a second mixed solution;
subjecting the first mixed solution, the second mixed solution, and the paint sludge-derived activated carbon to a third mixing, and subjecting a resulting mixture to a hydrothermal reaction to obtain a precursor material; and
calcining the precursor material to obtain the paint sludge-derived activated carbon-MOF composite electrode material.

In some embodiments, the carbonizing is conducted at a temperature of 500 °C to 1000 °C for 1 h to 4 h.

In some embodiments, the inorganic base includes at least one selected from the group consisting of sodium hydroxide, potassium hydroxide, sodium carbonate, and potassium carbonate; and the organic solvent for the first mixing and the organic solvent for the second mixing independently include at least one selected from the group consisting of methanol, ethanol, and N, N-dimethylformamide.

In some embodiments, the cerium salt includes at least one selected from the group consisting of cerium nitrate and cerium chloride; the iron salt includes at least one selected from the group consisting of iron nitrate and iron chloride; a molar ratio of the cerium salt to the iron salt is in a range of 1:1 to 2:1; and
a ratio of an amount of the metal salt to an amount of the inorganic base is in a range of 2-8 mmol:0.1-0.3 g.

In some embodiments, a molar ratio of the metal salt to the 2-methylimidazole is in a range of 2:5 to 8:20.

In some embodiments, the hydrothermal reaction is conducted at a temperature of 120 °C to 180 °C for 2 h to 5 h.

In some embodiments, a ratio of an amount of the metal salt to an amount of the paint sludge-derived activated carbon is in a range of 2-8 mmol 0.1-2 g.

In some embodiments, the calcining is conducted at a temperature of 100 °C to 300 °C for 1 h to 5 h.

The present disclosure further provides a paint sludge-derived activated carbon-MOF composite electrode material prepared by the method as described in the technical solutions above.

The present disclosure further provides use of the paint sludge-derived activated carbon-MOF composite electrode material as described in the technical solution above in hydrogen production by water electrolysis.

The present disclosure provides a method for preparing a paint sludge-derived activated carbon-MOF composite electrode material, including the following steps: carbonizing a paint sludge to obtain a paint sludge-derived activated carbon, where the paint sludge-derived activated carbon includes Al and CaCO₃; subjecting a metal salt, an inorganic base, and an organic solvent to a first mixing to obtain a first mixed solution, wherein the metal salt includes a mixed salt of a cerium salt and an iron salt; subjecting 2-methylimidazole and an organic solvent to a second mixing to obtain a second mixed solution; subjecting the first mixed solution, the second mixed solution, and the paint sludge-derived activated carbon to a third mixing, and subjecting a resulting mixture to a hydrothermal reaction to obtain a precursor material; and calcining the precursor material to obtain the paint sludge-derived activated carbon-MOF composite electrode material.

Some embodiments of the present disclosure have the following beneficial effects:
In the present disclosure, the paint sludge-derived activated carbon obtained after carbonization is rich in CaCO, and Al. In the in-situ synthesis of the metal organic framework (MOF), Al participates in MOF coordination, induces the redistribution of electrons and facilitates the formation of abundant oxygen vacancies (about 3.2 times higher than MOF alone), such that more active sites are exposed. Further, CaCO acts as a support structure to inhibit MOF agglomeration, resulting synergistic improvement in electrochemical performance. An electrocatalytic electrode prepared using an electrode active material has significantly improved electrochemical performance compared to an electrocatalytic electrode prepared using paint sludge-derived activated carbon alone.

In addition, in the present disclosure, the paint sludge-derived activated carbon-MOF composite electrode material is prepared by a hydrothermal method combined with calcination. The preparation method is simple, highly operational, efficient, and environmentally friendly, achieving the resource utilization of waste paint sludge.

### BRIEF DESCRIPTION OF THE DRAWINGS

FIG. 1 shows a scanning electron microscope image of a PAC catalyst for water electrolysis in an embodiment;

FIG. 2 shows a scanning electron microscope image of a CeFe-MOF catalyst for water electrolysis in an embodiment;

FIG. 3 shows a scanning electron microscope image of a CeFe-MOF/PAC catalyst for water electrolysis in an embodiment;

FIG. 4 shows a scanning electron microscope image of a CeFe-MOF/PAC-200 catalyst for water electrolysis in an embodiment;

FIG. 5 shows a high-resolution transmission electron microscope image of a CeFe-MOF/PAC-200 catalyst for water electrolysis in an embodiment;

FIG. 6 shows a selected area electron diffraction pattern of a CeFe-MOF/PAC-200 catalyst for water electrolysis in an embodiment;

FIG. 7 shows X-ray diffraction spectra of the PAC, CeFe-MOF, CeFe-MOF/PAC, and CeFe-MOF/PAC-200 catalysts for water electrolysis in an embodiment;

FIG. 8 shows Fourier transform infrared spectra of the CeFe-MOF, CeFe-MOF/PAC, and CeFe-MOF/PAC-200 catalysts for water electrolysis in an embodiment;

FIG. 9 shows electron paramagnetic resonance spectra of the CeFe-MOF, CeFe-MOF/PAC, and CeFe-MOF/PAC-200 0 catalysts for water electrolysis in an embodiment;

FIG. 10 shows C 1s X-ray photoelectron spectroscopy spectra of the PAC, CeFe-MOF, CeFe-MOF/PAC, and CeFe-MOF/PAC-200 catalysts for water electrolysis in an embodiment;

FIG. 11 shows N 1s X-ray photoelectron spectroscopy spectra of the PAC, CeFe-MOF, CeFe-MOF/PAC, and CeFe-MOF/PAC-200 catalysts for water electrolysis in an embodiment;

FIG. 12 shows 0 1s X-ray photoelectron spectroscopy spectra of the PAC, CeFe-MOF, CeFe-MOF/PAC, and CeFe-MOF/PAC-200 catalysts for water electrolysis in an embodiment;

FIG. 13 shows Fe 2p X-ray photoelectron spectroscopy spectra of the PAC, CeFe-MOF, CeFe-MOF/PAC, and CeFe-MOF/PAC-200 catalysts for water electrolysis in an embodiment;

FIG. 14 shows Ce 3d X-ray photoelectron spectroscopy spectra of the PAC, CeFe-MOF, CeFe-MOF/PAC, and CeFe-MOF/PAC-200 catalysts for water electrolysis in an embodiment;

FIG. 15 shows Al 2p X-ray photoelectron spectroscopy spectra of the PAC, CeFe-MOF, CeFe-MOF/PAC, and CeFe-MOF/PAC-200 catalysts for water electrolysis in an embodiment;

FIG. 16 shows the linear sweep voltammetry curves of the hydrogen evolution performance in water electrolysis of CeFe-MOF/PAC_{0.2}-200, CeFe-MOF/PAC_{0.5}-200, and CeFe-MOF/PAC_{1.0}-200 catalysts for water electrolysis in an alkaline electrolyte solution in an embodiment;

FIG. 17 shows the linear sweep voltammetry curves for the hydrogen evolution performance in water electrolysis of the PAC, CeFe-MOF, CeFe-MOF/PAC, and CeFe-MOF/PAC-200 catalysts for water electrolysis in alkaline, acidic or neutral electrolyte solutions;

FIG. 18 shows a graph comparing the overpotential and Tafel slope at a current density of 10 mA·cm² for the hydrogen evolution performance in water electrolysis of the PAC, CeFe-MOF, CeFe-MOF/PAC, and CeFe-MOF/PAC-200 catalysts for water electrolysis in alkaline, acidic or neutral electrolyte solutions in an embodiment;

FIG. 19 shows the 12 h constant-current chronopotentiometric curves at a current density of 10 mA·cm² for the hydrogen evolution performance in water electrolysis of the PAC, CeFe-MOF, CeFe-MOF/PAC, and CeFe-MOF/PAC-200 catalysts for water electrolysis in alkaline, acidic or neutral electrolyte solutions in an embodiment; and

FIG. 20 shows a graph comparing the turnover frequency and mass activity at an overpotential of 300 mV for the hydrogen evolution performance in water electrolysis of the PAC, CeFe-MOF, CeFe-MOF/PAC, and CeFe-MOF/PAC-200 catalysts for water electrolysis in alkaline, acidic or neutral electrolyte solutions in an embodiment.

### DETAILED DESCRIPTION OF THE EMBODIMENTS

The present disclosure provides a method for preparing a paint sludge-derived activated carbon-MOF composite electrode material (i.e., a composite electrode material of a paint sludge-derived activated carbon and MOF), including the following steps:
carbonizing a paint sludge to obtain a paint sludge-derived activated carbon, where the paint sludge-derived activated carbon includes Al and CaCO₃;
subjecting a metal salt, inorganic base, and an organic solvent to a first mixing to obtain a first mixed solution, wherein the metal salt includes a mixed salt of a cerium salt and an iron salt;
subjecting 2-methylimidazole and an organic solvent to a second mixing to obtain a second mixed solution;
subjecting the first mixed solution, the second mixed solution, and the paint sludge-derived activated carbon to a third mixing, and subjecting a resulting mixture to a hydrothermal reaction to obtain a precursor material; and
calcining the precursor material to obtain the paint sludge-derived activated carbon-MOF composite electrode material.

In the present disclosure, a paint sludge is carbonized to obtain a paint sludge-derived activated carbon. The source of the paint sludge is not specifically limited in the present disclosure, and any paint sludge that is well known to the skilled in the art can be used. In some embodiments of the present disclosure, the carbonizing is conducted at a temperature of 500 °C to 1000 °C, and specifically is 500 °C, 600 °C, 700 °C, 800 °C, 900 °C, or 1000 °C; the carbonizing is conducted for 1 h to 4 h, and specifically is 1 h, 2 h, 3 h, or 4 h; and the carbonizing is conducted in a muffle furnace. In the present disclosure, after the carbonizing, a resulting material is cooled to room temperature. In the present disclosure, the paint sludge-derived activated carbon includes Al and CaCO₃. In some embodiments, in the paint sludge-derived activated carbon, a content in percentage by mass of Al is 20% to 50%, and a content in percentage by mass of CaCO, is 2% to 10%; and the paint sludge-derived activated carbon has an average particle size of 2 μm to 10 μm.

In the present disclosure, a metal salt, an inorganic base, and an organic solvent are subjected to a first mixing to obtain a first mixed solution.

In some embodiments of the present disclosure, the inorganic base includes at least one selected from the group consisting of sodium hydroxide, potassium hydroxide, sodium carbonate, and potassium carbonate; and the organic solvents includes at least one selected from the group consisting of methanol, ethanol, and N, N-dimethylformamide.

In the present disclosure, the metal salt includes a mixed salt of a cerium salt and an iron salt. In some embodiments of the present disclosure, the cerium salt includes at least one selected from the group consisting of cerium nitrate and cerium chloride; and the cerium nitrate is preferably cerium nitrate hexahydrate; the iron salt includes at least one selected from the group consisting of iron nitrate and iron chloride; and the iron nitrate is preferably ferric nitrate nonahydrate; and a molar ratio of the cerium salt to the iron salt is in a range of 1:1 to 2:1. In some embodiments of the present disclosure, a ratio of an amount of the metal salt to an amount of the inorganic base is in a range of 2-8 mmol:0.1-0.3 g. In some embodiments of the present disclosure, a ratio of an amount of the metal salt to an amount of the organic solvent is in a range of 2-8 mmol:20-40 mL. In some embodiments of the present disclosure, the first mixing is conducted under stirring.

In the present disclosure, 2-methylimidazole and an organic solvent are subjected to a second mixing to obtain a second mixed solution. In some embodiments of the present disclosure, the type of the organic solvent is the same as that of the organic solvent used in the first mixing, and will not be described here. In some embodiments of the present disclosure, a molar ratio of the metal salt to the 2-methylimidazole is in a range of 2:5 to 8:20; and a ratio of an amount of the 2-methylimidazole to an amount of the organic solvent is in a range of 5-20 mmol:10-40 mL.

After obtaining the paint sludge-derived activated carbon, the first mixed solution, and the second mixed solution, in the present disclosure, the first mixed solution, the second mixed solution, and the paint sludge-derived activated carbon are subjected to a third mixing, and a hydrothermal reaction is conducted on a resulting mixture to obtain a precursor material. In some embodiments of the present disclosure, a ratio of an amount of the metal salt to an amount of the paint sludge-derived activated carbon is in a range of 2-8 mmol:0.1-2 g. In some embodiments of the present disclosure, the third mixing is conducted out under stirring. In some embodiments of the present disclosure, the hydrothermal reaction is conducted at a temperature of 120 °C to 180 °C, and specifically is 120 °C, 130 °C, 140 °C, 150 °C, 160 °C, 170 °C, or 180 °C; and the hydrothermal reaction is conducted for 2 h to 5 h, and specifically is 2 h, 3 h, 4 h, or 5 h. In some embodiments of the present disclosure, the hydrothermal reaction is conducted in a hydrothermal reaction kettle with a polytetrafluoroethylene liner. In some embodiments of the present disclosure, after the hydrothermal reaction, a resulting system is cooled to room temperature, followed by washing and drying in sequence; and the washing is preferably alternating centrifugal washing with deionized water and absolute ethanol. In the present disclosure, during the hydrothermal reaction, the metal salt undergoes hydrolysis under high temperature and high pressure to form metal clusters, and the organic ligand is deprotonated and the deprotonated organic ligand will achieve self-assembly through the coordination of functional groups with metal clusters, thus allowing the metal organic framework to be loaded on activated carbon.

After obtaining the precursor material, in the present disclosure, the precursor material is calcined to obtain the paint sludge-derived activated carbon-MOF composite electrode material. In some embodiments of the present disclosure, the calcining is conducted at a temperature of 100 °C to 300 °C, and specifically is 100 °C, 200 °C, or 300 °C; the calcining is conducted for 1 h to 5 h, and specifically is 1 h, 2 h, 3 h, 4 h, or 5 h; and the calcining is conducted in a protective atmosphere, preferably nitrogen. In some embodiments of the present disclosure, in the process of calcination, the method of low-temperature calcination is used, which can remove the residual solvent from the material. Some organic ligands decompose to form nitrogen residues, thereby exposing more metal sites; moreover, the oxidation state of the metal sites is also changed, which further regulates the mixed oxidation state of Ce sites, thus allowing the electrode active material to have a more favorable electron state and more abundant oxygen vacancy contents.

The present disclosure further provides a paint sludge-derived activated carbon-MOF composite electrode material prepared by the method as described in the technical solutions above.

The present disclosure further provides use of the paint sludge-derived activated carbon-MOF composite electrode material as described in the technical solution above in hydrogen production by water electrolysis.

Unless otherwise specified, the materials and equipment used in the present disclosure are commercially available in the art.

The technical solutions in the present disclosure will be described clearly and completely below with reference to the examples of the present disclosure. Apparently, the described examples are merely some, rather than all of the examples of the present disclosure. On the basis of the examples of the present disclosure, all other examples that can be obtained by those of ordinary skill in the art without creative efforts shall fall within the scope of the present disclosure.

### Example 1

A paint sludge was calcined (carbonized) in a muffle furnace at 700 °C for 2 h and then cooled to room temperature to obtain a paint sludge-derived activated carbon (PAC). In the paint sludge-derived activated carbon, a content of Al was 37.2% by mass, and a content of CaCO, was 7.8% by mass. The paint sludge-derived activated carbon had an average particle size of 5 μm.

2 mM of cerium nitrate hexahydrate, 2 mM of ferric nitrate nonahydrate, and 0.2 g of sodium hydroxide were dissolved in 30 mL of methanol and stirred until uniform to obtain a first mixed solution with a reddish-brown color.

10 mM of 2-methylimidazole was dissolved in 20 mL of methanol to obtain a second mixed solution with a colorless clear color.

The first mixed solution and the second mixed solution were mixed, 1 g of the paint sludge-derived activated carbon was added thereto, and a resulting mixture was stirred until uniform and then transferred to a hydrothermal reaction kettle with a polytetrafluoroethylene liner, and then subjected to a reaction at 150 °C for 3 hours. After the reaction was completed, a resulting system was cooled to room temperature; a resulting product was alternately centrifugally washed with deionized water and absolute ethanol, and then dried. A precursor material was collected and denoted as CeFe-MOF/PAC.

The precursor material was placed in a quartz boat, and then the quartz boat was placed in a tube furnace, followed by calcination at 200 °C for 3 h under a nitrogen atmosphere to obtain a paint sludge-derived activated carbon-MOF composite electrode material, which was denoted as CeFe-MOF/PAC₁-200 or CeFe-MOF/PAC-200.

### Example 2

A paint sludge-derived activated carbon-MOF composite electrode material was prepared following the method in Example 1, except that an addition amount of a paint sludge-derived activated carbon was 0.2 g, and a resulting paint sludge-derived activated carbon-MOF composite electrode material was denoted as CeFe-MOF/PAC_{0.2}-200.

### Example 3

A paint sludge-derived activated carbon-MOF composite electrode material was prepared following the method in Example 1, except that an addition amount of a paint sludge-derived activated carbon was 0.5 g, and a resulting paint sludge-derived activated carbon-MOF composite electrode material was denoted as CeFe-MOF/PAC_{0.5}-200.

### Comparative Example 1

2 mM of cerium nitrate hexahydrate, 2 mM of ferric nitrate nonahydrate, and 0.2 g of sodium hydroxide were dissolved in 30 mL of methanol and stirred until uniform to obtain a first mixed solution with a brownish-red color.

10 mM of 2-methylimidazole was dissolved in 20 mL of methanol to obtain a second mixed solution with a colorless clear color.

The first mixed solution and the second mixed solution were mixed, stirred until uniform and then transferred to a hydrothermal reaction kettle with a polytetrafluoroethylene liner, and then subjected to a reaction at 150 °C for 3 hours. After the reaction was completed, a resulting system was cooled to room temperature; a resulting product was alternatively centrifugally washed with deionized water and absolute ethanol, and then dried; and a resulting product was collected and denoted as CeFe-MOF.

### Performance Tests

### Test Example 1

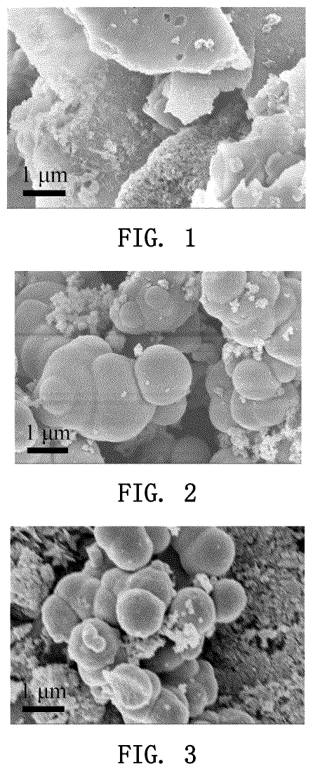

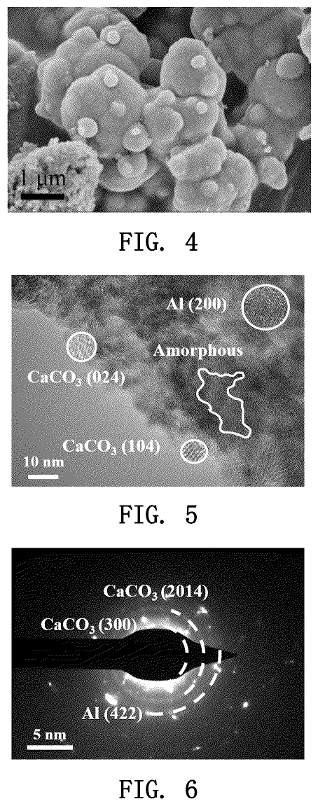

FIGS. 1 to 4 show SEM images of PAC, CeFe-MOF, CeFe-MOF/PAC, and CeFe-MOF/PAC-200, respectively. As can be seen, the flake-like structure of PAC (FIG. 1) provides anchoring sites for CeFe-MOF (FIG. 2) nanospheres, reducing agglomeration. Moreover, the composite CeFe-MOF/PAC-200 (FIG. 4) shows no significant structural changes compared to CeFe-MOF/PAC (FIG. 3).

FIG. 5 shows an HRTEM image of CeFe-MOF/PAC-200, and FIG. 6 shows an SEAD image of CeFe-MOF/PAC-200. The crystal lattice patterns of CaCO₃ and Al are clearly visible in the HRTEM image of FIG. 5. In FIG. 6, the CeFe-MOF/PAC-200 shows a bright diffraction ring accompanied by diffuse rings, indicating that the CeFe-MOF/PAC-200 has both a polycrystalline structure and an amorphous structure.

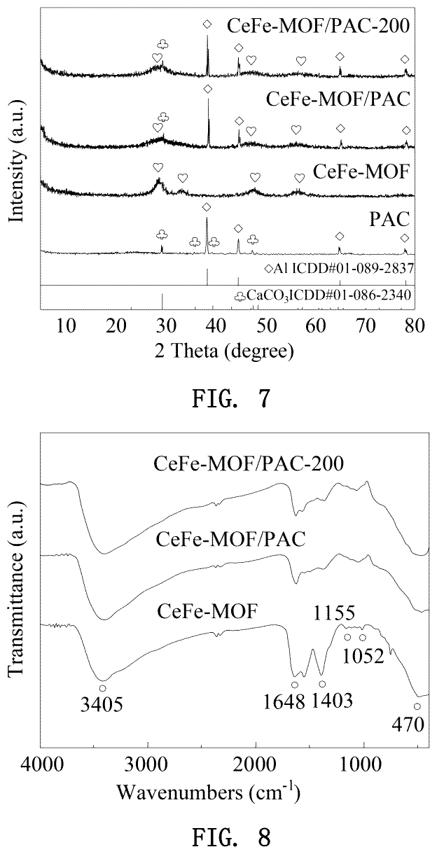

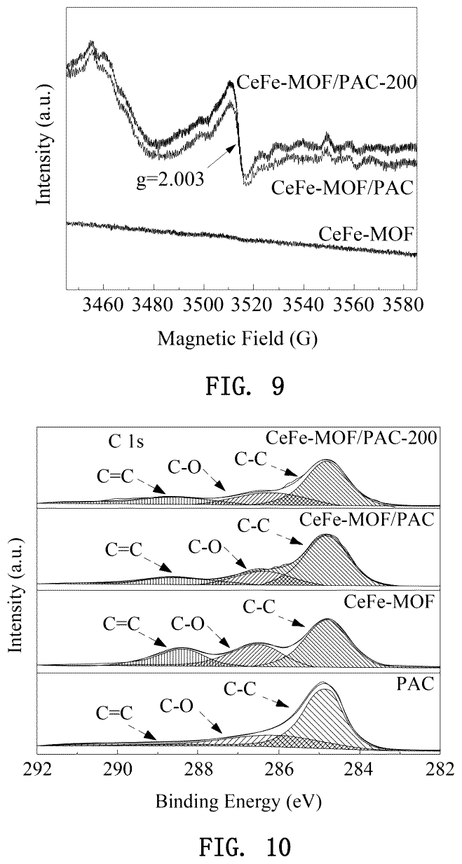

FIGS. 7 to 9 show XRD spectra, FT-IR spectra, and EPR spectra of PAC, CeFe-MOF, CeFe-MOF/PAC, and CeFe-MOF/PAC-200, respectively. As can be seen from the XRD spectra (FIG. 7), CeFe-MOF/PAC-200 has a higher crystallinity. In addition, compared with CeFe-MOF, the CeFe-MOF/PAC-200 shows no significant change in crystal structure, indicating that the composite strategy can maintain the integrity of the crystal structure of CeFe-MOF while introducing PAC. In the FT-IR spectra (FIG. 8), the absorption peaks at 1648 cm⁻¹ and 1403 cm⁻¹ are attributed to the vibration of the C═N and C—N bonds of imidazole. The decrease in the peak intensities of the C═N and C—N bonds of CeFe-MOF/PAC-200 and CeFe-MOF/PAC, compared to CeFe-MOF, should be attributed to the introduction of Al during the composite formation of PAC and CeFe-MOF, since Al participates in the coordination of MOF, increasing the number of metal active center sites. As can be seen from the EPR spectra (FIG. 9), CeFe-MOF does not have a significant oxygen vacancy response signal at g=2.003, and a strong oxygen vacancy signal appears for PAC-MOF composite, indicating that PAC induces the formation of abundant oxygen vacancies in the CeFe-MOF.

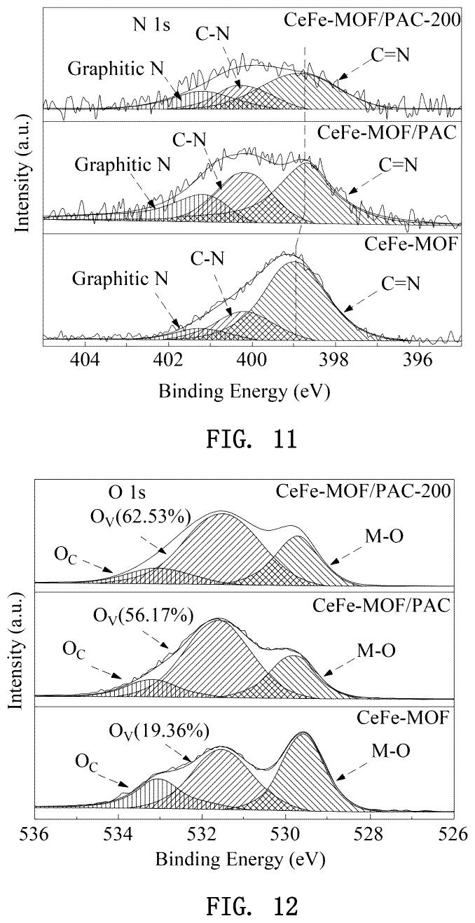

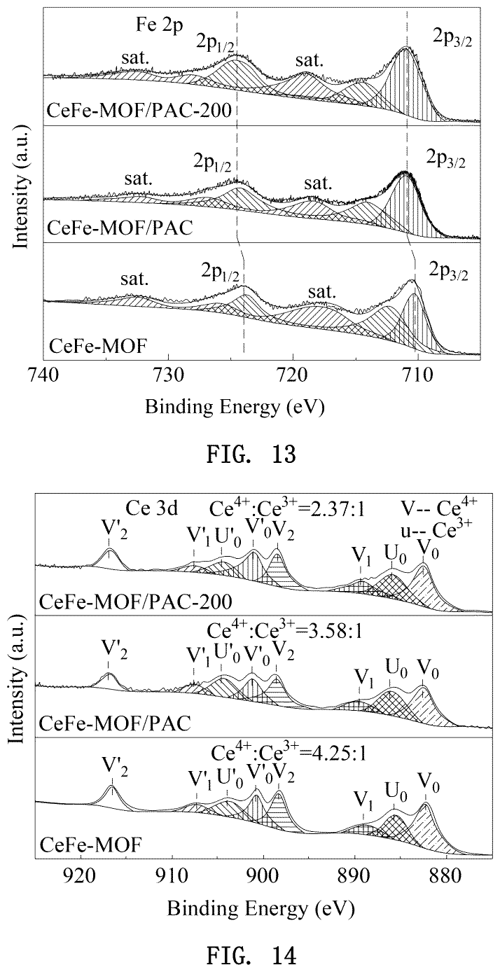

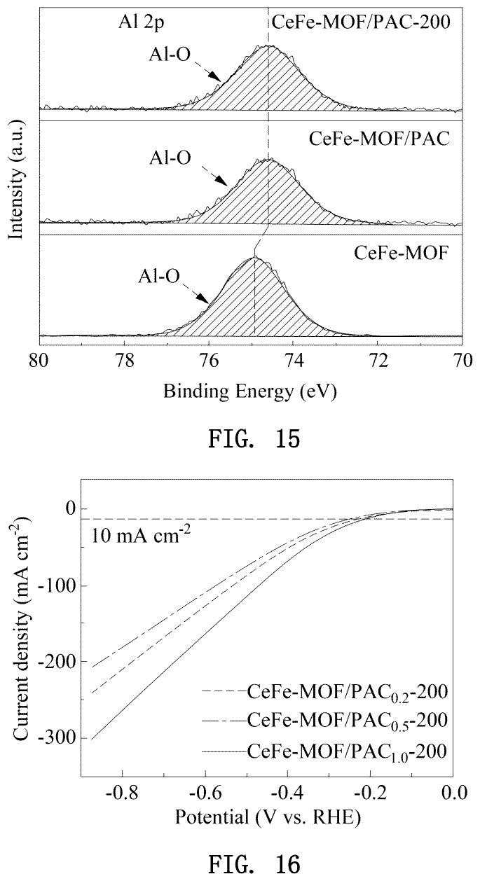

FIGS. 10 to 15 show the XPS spectra of C 1s (FIG. 10), N 1s (FIG. 11), O 1s (FIG. 12), Fe 2p (FIG. 13), Ce 3d (FIG. 14), and Al 2p (FIG. 15). In FIG. 10, the oxygen-containing functional groups of CeFe-MOF gradually decrease with the introduction of PAC. As can be seen from FIG. 11, the electron density around the N atoms of CeFe-MOF/PAC-200 increases, which will increase the charge transport rate in the electrocatalytic process. In FIG. 12, the oxygen vacancy content of the CeFe-MOF/PAC-200 is significantly increased. FIG. 13 shows the positive shift in the binding energy of Fe in CeFe-MOF/PAC and CeFe-MOF/PAC-200 after PAC and MOF recombination, indicating that some electrons are transferred from the Fe element to the Ce element. FIG. 14 illustrates the coexistence of Ce³⁺ and Ce⁴⁺ in CeFe-MOF. The composite strategy significantly increases the Ce³⁺ content in the CeFe-MOF/PAC-200. Low-valence cerium ions can achieve faster charge transfer rates and also generate defects on the surface of MOF, thereby increasing the active specific surface area of the catalyst. In FIG. 15, the Al—O binding energy of CeFe-MOF/PAC-200 is reduced because, after recombination, the Al is coordinated with the MOF in PAC, and some electrons of Fe are also transferred to Al, significantly regulating the electronic structure of CeFe-MOF. As a result, CeFe-MOF/PAC-200 has a higher electron transfer efficiency and a more favorable electron state.

### Test Example 2

The electrochemical performance of PAC, CeFe-MOF, CeFe-MOF/PAC and CeFe-MOF/PAC-200, which were used as an active material, respectively, were tested as follows:
In the present disclosure, a versatile electrochemical tester CHI660E from Shanghai Chenhua was used in the electrochemical performance tests. In a three-electrode system, a platinum plate with an area of 1×1 cm², a single salt bridge mercury oxide electrode, and solutions of different pH (1 M KOH, 0.5 M H₂SO₄ and 1 M PBS) were selected as a counter electrode, a reference electrode, and electrolyte solutions, respectively, in the tests. The electrochemical properties of the active materials were tested by preparing an electrode plate as a working electrode by coating an active material on a 2×1 cm² foam nickel sheet, wherein the electrochemical performance tests mainly include a linear sweep voltammetry (LSV) test, a cyclic voltammetry (CV) test, and a cyclic stability test.

The TOF and MA values of the electrode materials can be calculated based on the LSV curve, the mass of the active materials, and the integrated area of the CV curve. The TOF was calculated according to a formula as follows:

$$TOF = \frac{\vert j \vert \times A}{α \times F \times N}$$

where
j refers to a current density, mA·cm²;
A refers to an active area of electrode, cm²;
α refers to the number of electrons transferred per molecule of target product formed, which was 2 in HER;
F refers to Faraday constant, 96485 C·mol⁻¹; and
N refers to number of moles of active material, mol.

The MA value was calculated according to a formula as follows:

$$MA = \frac{\vert j \vert}{m}$$

where
j refers to a current density, A·cm⁻²; and
M refers to a mass of active material, g.

FIG. 16 shows a graph comparing the electrochemical hydrogen evolution reaction performance of the composite electrode materials CeFe-MOF/PACₓ-200 (X=0.2, 0.5, and 1) obtained in Examples 1-3 in an alkaline electrolyte solution, specifically are the LSV curves. As can be seen, when the current density is 10 mA·cm⁻², the overpotentials of CeFe-MOF/PAC_{0.2}-200, CeFe-MOF/PAC_{0.5}-200, and CeFe-MOF/PAC₁-200 are 227 mV, 236 mV, and 206 mV, respectively.

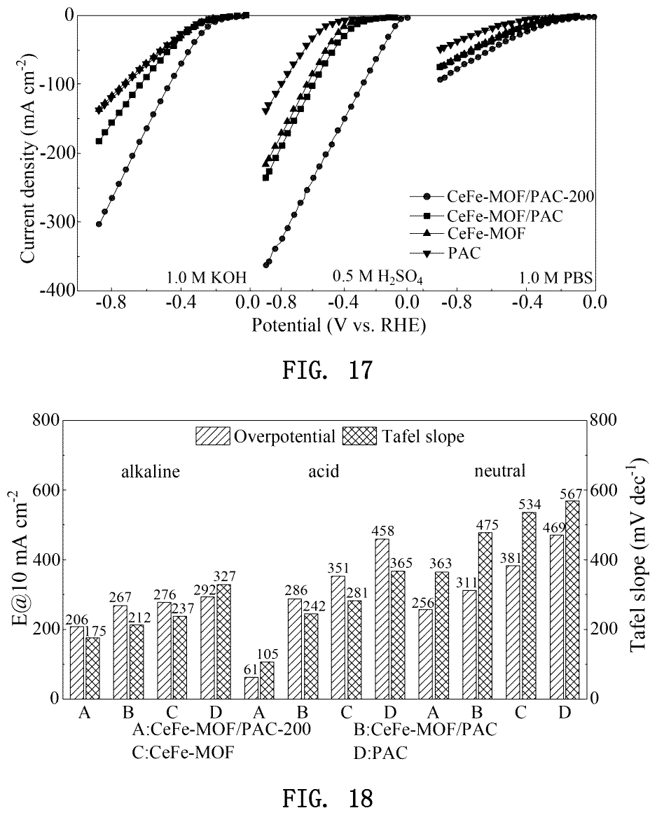

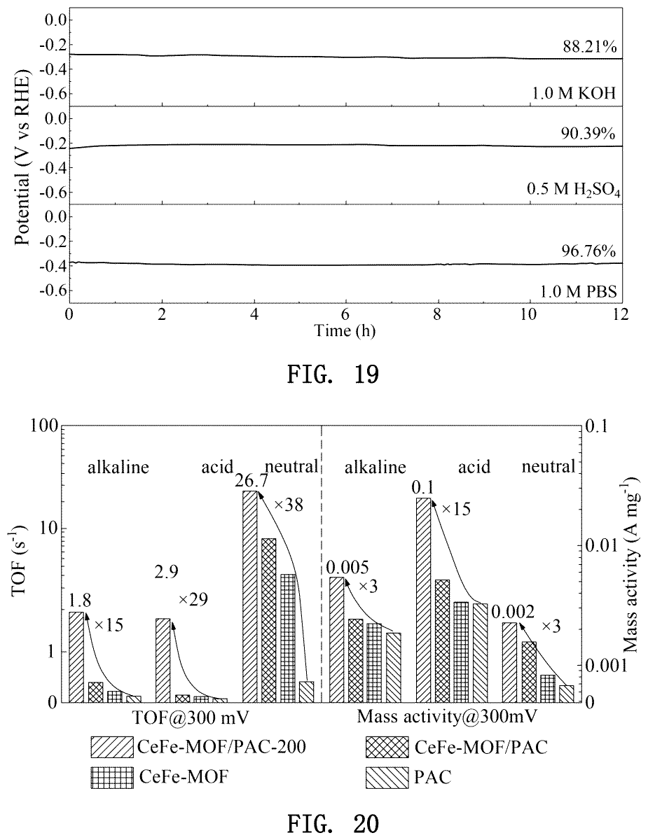

FIGS. 17 to 20 show a graph comparing the electrochemical hydrogen evolution performance of CeFe-MOF/PAC-200, CeFe-MOF/PAC, CeFe-MOF, and PAC, specifically are the LSV curves (FIG. 17); a graph comparing the overpotential and Tafel slope (FIG. 18); a cyclic stability profile of CeFe-MOF/PAC-200 (FIG. 19); and corresponding TOF and MA values (FIG. 20).

As can be seen from the results of the electrocatalytic water decomposition HER performance test diagrams shown in FIGS. 17-20, the electrochemical tests were carried out in three electrolyte solutions: alkaline (1 M KOH), acidic (0.5 M H₂SO₄) and neutral (1 M PBS), respectively. The specific test results are shown in Table 1, where the overpotential is the overpotential at a current density of 10 mA·cm².

TABLE 1
Electrochemical performance test results
in different electrolyte solutions

| | | Overpotential | Tafel slope |
|---|---|---|---|
| | Electrolyte | (mV) | (mV · dec⁻¹) |
| CeFe-MOF/PAC-200 | 1M KOH | 206 | 175 |
| CeFe-MOF/PAC | 1M KOH | 267 | 212 |
| CeFe-MOF | 1M KOH | 276 | 237 |
| PAC | 1M KOH | 292 | 327 |
| CeFe-MOF/PAC-200 | 0.5M H₂SO₄ | 61 | 105 |
| CeFe-MOF/PAC | 0.5M H₂SO₄ | 286 | 242 |
| CeFe-MOF | 0.5M H₂SO₄ | 351 | 281 |
| PAC | 0.5M H₂SO₄ | 458 | 365 |
| CeFe-MOF/PAC-200 | 1M PBS | 256 | 363 |
| CeFe-MOF/PAC | 1M PBS | 311 | 475 |
| CeFe-MOF | 1M PBS | 381 | 534 |
| PAC | 1M PBS | 469 | 567 |

As can be seen from FIG. 17 and Table 1, when the current density is 10 mA·cm⁻², the CeFe-MOF/PAC-200 has the smallest overpotentials of 206 mV (alkaline), 61 mV (acidic) and 256 mV (neutral), demonstrating a significant performance improvement over PAC and CeFe-MOF. FIG. 18 shows a graph comparing the overpotential and Tafel slope. As can be seen, the Tafel slope of CeFe-MOF/PAC-200 is significantly reduced, which is 175 mV·dec⁻¹ (alkaline), 105 mV. December 1 (acidic), and 363 mV·dec⁻¹ (neutral), respectively, indicating that the composite strategy allows the CeFe-MOF/PAC-200 to have faster reaction kinetics. As can be seen in FIG. 19, the decay of the performance of CeFe-MOF/PAC-200 is not significant after the 12 h electrocatalytic stability test, retaining 88.21% (alkaline), 90.39% (acidic) and 96.76% (neutral) of the initial performance. FIG. 20 shows a comparison of calculated TOF and MA values. As can be seen, the catalytic activity of CeFe-MOF/PAC-200 is significantly improved.

The present disclosure is based on an interface engineering composite strategy of PAC and CeFe-MOF, which achieves the dual goals of electronic structure regulation and active site optimization by taking advantage of the unique role of CaCO, and Al in the paint sludge, and significantly increases the oxygen vacancy content of CeFe-MOF, providing an innovative path for efficient use of waste resources.

Although the embodiments described above have provided a detailed description of the present disclosure, they are only a part of, rather than all of the embodiments of the present disclosure. All other embodiments that can be obtained according to the embodiments of the present disclosure without creative efforts shall fall within the scope of the present disclosure.

What is claimed is:

1. A method for preparing a paint sludge-derived activated carbon-metal organic framework (MOF) composite electrode material, comprising:
carbonizing a paint sludge to obtain a paint sludge-derived activated carbon, wherein the paint sludge-derived activated carbon comprises Al and CaCO₃;
subjecting a metal salt, an inorganic base, and a first organic solvent to a first mixing to obtain a first mixed solution, wherein the metal salt comprises a mixed salt of a cerium salt and an iron salt;
subjecting 2-methylimidazole and a second organic solvent to a second mixing to obtain a second mixed solution;
subjecting the first mixed solution, the second mixed solution, and the paint sludge-derived activated carbon to a third mixing, and subjecting a resulting mixture to a hydrothermal reaction to obtain a precursor material; and
calcining the precursor material to obtain the paint sludge-derived activated carbon-MOF composite electrode material.

2. The method of claim 1, wherein the carbonizing is conducted at a temperature of 500 °C to 1000 °C for 1 hour to 4 hours.

3. The method of claim 1, wherein the inorganic base comprises at least one selected from the group consisting of sodium hydroxide, potassium hydroxide, sodium carbonate, and potassium carbonate; and
the first organic solvent for the first mixing and the second organic solvent for the second mixing independently comprise at least one selected from the group consisting of methanol, ethanol, and N, N-dimethylformamide.

4. The method of claim 1, wherein the cerium salt comprises at least one selected from the group consisting of cerium nitrate and cerium chloride; the iron salt comprises at least one selected from the group consisting of iron nitrate and iron chloride; and a molar ratio of the cerium salt to the iron salt is in a range of 1:1 to 2:1; and
a ratio of an amount of the metal salt to an amount of the inorganic base is in a range of 2-8 mmol:0.1-0.3 g.

5. The method of claim 1, wherein a molar ratio of the metal salt to the 2-methylimidazole is in a range of 2:5 to 8:20.

6. The method of claim 1, wherein the hydrothermal reaction is conducted at a temperature of 120 °C to 180 °C for 2 hours to 5 hours.

7. The method of claim 1, wherein a ratio of an amount of the metal salt to an amount of the paint sludge-derived activated carbon is in a range of 2-8 mmol:0.1-2 g.

8. The method of claim 1, wherein the calcining is conducted at a temperature of 100 °C to 300 °C for 1 hour to 5 hours.

9. A paint sludge-derived activated carbon-MOF composite electrode material prepared by the method of claim 1.

10. The method of claim 3, wherein the cerium salt comprises at least one selected from the group consisting of cerium nitrate and cerium chloride; the iron salt comprises at least one selected from the group consisting of iron nitrate and iron chloride; and a molar ratio of the cerium salt to the iron salt is in a range of 1:1 to 2:1; and
a ratio of an amount of the metal salt to an amount of the inorganic base is in a range of 2-8 mmol:0.1-0.3 g.

11. The method of claim 5, wherein the hydrothermal reaction is conducted at a temperature of 120 °C to 180 °C for 2 hours to 5 hours.

12. The paint sludge-derived activated carbon-MOF composite electrode material of claim 9, wherein the carbonizing is conducted at a temperature of 500 °C to 1000 °C for 1 hour to 4 hours.

13. The paint sludge-derived activated carbon-MOF composite electrode material of claim 9, wherein the inorganic base comprises at least one selected from the group consisting of sodium hydroxide, potassium hydroxide, sodium carbonate, and potassium carbonate; and
the first organic solvent for the first mixing and the second organic solvent for the second mixing independently comprise at least one selected from the group consisting of methanol, ethanol, and N, N-dimethylformamide.

14. The paint sludge-derived activated carbon-MOF composite electrode material of claim 9, wherein the cerium salt comprises at least one selected from the group consisting of cerium nitrate and cerium chloride; the iron salt comprises at least one selected from the group consisting of iron nitrate and iron chloride; and a molar ratio of the cerium salt to the iron salt is in a range of 1:1 to 2:1; and
a ratio of an amount of the metal salt to an amount of the inorganic base is in a range of 2-8 mmol:0.1-0.3 g.

15. The paint sludge-derived activated carbon-MOF composite electrode material of claim 9, wherein a molar ratio of the metal salt to the 2-methylimidazole is in a range of 2:5 to 8:20.

16. The paint sludge-derived activated carbon-MOF composite electrode material of claim 9, wherein the hydrothermal reaction is conducted at a temperature of 120 °C to 180 °C for 2 hours to 5 hours.

17. The paint sludge-derived activated carbon-MOF composite electrode material of claim 9, wherein a ratio of an amount of the metal salt to an amount of the paint sludge-derived activated carbon is in a range of 2-8 mmol:0.1-2 g.

18. The paint sludge-derived activated carbon-MOF composite electrode material of claim 9, wherein the calcining is conducted at a temperature of 100 °C to 300 °C for 1 hour to 5 hours.
